(19) United States
(12) Patent Application Publication
(10) Pub. No.: US 2024/0206404 A1
(43) Pub. Date: Jun. 27, 2024

(54) FLOWER BINDING DEVICE AND METHOD FOR BINDING FLOWERS

(71) Applicant: FLEUROP-INTERFLORA NEDERLAND B.V., VEENENDAAL (NL)

(72) Inventors: Robert Antonius Cornelius Schrijvers, VEENENDAAL (NL); Johannes Cornelis De Zwart, VEENENDAAL (NL)

(21) Appl. No.: 18/566,411

(22) PCT Filed: Apr. 29, 2022
(86) PCT No.: PCT/NL2022/050232

§ 371 Date: Dec. 1, 2023

(30) Foreign Application Priority Data
Apr. 29, 2021 (NL) 2028091

(51) Int. Cl. A01G 5/00

(52) U.S. Cl. CPC A01G 5/00

(57) ABSTRACT

A flower-binding device for binding a bunch of flowers is provided. The flower-binding device includes a strip-shaped element with a first end piece and a second end piece and has a substantially circular shape in the load-free state. The strip-shaped element includes a guide member for allowing the first and the second end piece to mutually engage with each other, a locking device for locking the guide member in a closed position of the flower-binding device, and a manipulating device for manipulating the position of the strip-shaped element with one hand of a user. A method for binding flowers is also provided.

### CROSS-REFERENCE TO RELATED APPLICATIONS

Priority is claimed to International Application No. PCT/NL2022/050232 filed on Apr. 29, 2022, which claims priority to Netherlands Application No. 2028091 filed on Apr. 29, 2021, the entire disclosures of which are hereby incorporated by reference herein.

The present inventive concept relates to a flower-binding device adapted for binding a bunch of flowers and to the binding of a bunch of flowers using a flower-binding device.

### BACKGROUND

Flowers are usually sold in bunches or bouquets. Bunches and bouquets may vary in size. Sometimes, the flowers are of the same variety, sometimes different flowers are combined and arranged to form a bouquet. In this document, the term bunch is deemed to refer to both a bunch and a bouquet of flowers.

Usually, the flowers in a bunch are held together by means of a continuous elastic band which is first hooked around one or a few stems of the bunch, following which the elastic band is wound around the stems of the entire bunch a few times. Finally, the remaining part of the elastic band is again hooked around one or a few stems of the bunch. This is a cumbersome procedure which requires a degree of experience and skill from the person who performs these tasks. After all, the bunch has to be held together in one hand during the operation and the elastic band has to be arranged around the bunch using the other hand. The elastic band has to be tied around the stems of the bunch sufficiently tightly in order to keep the bunch together.

### SUMMARY

A person who wants to put a bunch of flowers which he or she has bought or been given in a vase should cut off the ends of the stems with a sharp knife in order to extend the life of the flowers. In order to be able to readily access the ends with a knife, the user often removes the elastic band which then has to be arranged around the stems again after cutting in order to maintain the arrangement. As this is difficult, it is sometimes omitted and the flowers are then arranged loosely in a vase, with the risk that the bunch fans out (excessively). The user does not have the option either to influence the angle of the stems and thus the width of the bunch by binding the stems more tightly or more loosely, at least not without untying the elastic band.

An object of the present inventive concept provides a flower-binding device which makes it easier for a user, that is to say a flower binder, flower seller or consumer, to bind a bunch of flowers together once they have been gathered together. The present inventive concept provides a flower binding device for binding a bunch of flowers, the flower-binding device comprising:
a strip-shaped element with a first end piece and a second end piece, the strip-shaped element having a substantially circular shape in the load-free state,
wherein the strip-shaped element is provided with engagement means for causing the first and the second end piece to mutually engage with each other in an overlapping, closed position of the flower-binding device,
wherein locking means are provided which are adapted for locking the engagement means in a closed position of the flower-binding device
wherein at least one manipulating means is provided on the strip-shaped element for manipulating the position of the strip-shaped element by means of one hand of a user, that is to say the degree to which the first end piece and the second end piece of the strip-shaped element overlap each other or are spaced apart, respectively.

A user is then able to hold a bunch of flowers in one hand, securely clasping the stems, and grasp the flower-binding device at the at least one manipulating means and a possible second manipulating means or the strip-shaped, or strip-like, element, in the other hand, in order to open the flower-binding device (move the ends away from each other), move the stems through the opening and subsequently close the flower-binding device and then lock it with the locking means.

European patent application EP 0 999 110 A2 describes a band-type clamp for fastening a brake line to a round shaft of a motor vehicle. The clamp is made from two semi-circular strip-shaped parts which are connected to each other by three beam-shaped structure elements and which each have an end, which ends can engage with each other. The clamp has two gripping elements, each of which has to be grasped by a different hand in order to be able to manipulate the clamp correctly. In addition, the beam-shaped structure elements prevent manipulation with one hand.

Preferably, the strip-shaped, or strip-like, element is made from a substantially dimensionally stable, yet flexible material which returns to its original shape in the load-free state. In the load-free state, it has a substantially circular shape. In this document, the term “circular” is understood to mean that the strip forms a contour which encloses an area in which stems of a bunch of flowers to be bound are (to be) accommodated and wherein the first and the second end piece of the strip-shaped element come together. Here, the expression “substantially circular” is understood to mean that the first and the second end piece pass one another/overlap, thus describing a completely circular contour, or the first and the second end approach each other with only a few centimeters in between, preferably at most 1 cm, more preferably at most 2 cm and even more preferably at most 4 cm, in which case no fully closed contour is achieved. Seemingly, the term “circular” describes a round contour, but in practice and also in this document, it is understood to mean circumferential, and the shape is certainly not limited to a round shape; the contour may also be oval, polygonal or otherwise. The contour does not have to be smooth, but may, for example, comprise a bend or incision around which two parts of the strip-shaped element situated on either side of the bend or incision may pivot or hinge.

According to the present inventive concept, the strip-shaped element is provided with engagement means which are adapted for causing the first and the second end piece to mutually engage with each other in an overlapping, closed position of the strip-shaped element.

The engagement means may comprise a frame which is provided on the first or the second end piece of the strip-shaped element, preferably on the inner side thereof, and is adapted for receiving the other end piece when the flower-binding device is moved from an open position to a closed position. The other end piece is then enclosed in the frame as it were, so that it is held in a position adjoining the first-mentioned end piece in the closed position of the strip-shaped element. The engagement means may comprise cams or a toothing on the first or second end piece which are adapted for engaging with a corresponding engagement means on the other end.

Locking means are provided which are adapted for locking the engagement means in a closed position of the flower-binding device. The locking means may moreover be incorporated in, that is to say may form part of or may even be formed by, the engagement means. The locking means may comprise a click-fit connection or a form-fitted or friction-fitted connection which prevents an engagement of or by the engagement means from being released in an undesirable or unintentional way.

At least one manipulating means is provided on the strip-shaped element and is adapted for manipulating the position, that is to say the shape, of the strip-shaped element by means of one hand of a user. In this case, the term “position” is the size of the opening between the first and the second end piece of the strip-shaped element in the case of an open contour and the degree of mutual overlap of the first and second end piece of the strip-shaped element in the case of a closed contour. During manipulating, the open and closed contour of the strip-shaped element may blend into one another.

When arranging a flower-binding device according to the present inventive concept around a bunch or bouquet, a user grabs the strip-shaped element on the outer side with his/her thumb and a finger of one hand, in which case at least the thumb or the finger engages with the at least one manipulating means. The outer side, or outer contour, of the strip-shaped element is the side of the strip-shaped element which is turned away from the enclosed area. Using the manipulating means, the user optionally first bends the flower-binding device open, more particularly open to such a degree that the distance between the first and the second end piece of the strip-shaped element is sufficiently large to allow the stems of a bunch to be bound to move in between. When the stems are in the enclosed area, the user can squeeze the flower-binding device by means of his/her thumb and finger, so that the first and second end piece of the strip-shaped element move toward each other, subsequently overlap each other and engage with each other, and continue to squeeze until the flower-binding device encloses the stems of the flowers in a sufficiently firm manner. The locking means are brought into a position which locks the flower-binding device. The flowers are now bound by the flower-binding device, all this having been executed using only one hand or even only a thumb and a finger. Thus, anobject of the present inventive concept is achieved by the flower-binding device.

In a preferred embodiment of the flower-binding device, the at least one manipulating means comprises two manipulating means. In this case, it is possible to manipulate the position of the flower-binding device using both the thumb and the finger with which the flower-binding device is being grasped.

It is preferred if the at least one manipulating means is provided on the outwardly facing side of the strip-shaped element and extends, at least in a manipulating position, at an angle with respect to the strip-shaped element. The angle encloses an angle with the strip-shaped element, more particularly the shortest part thereof measured from the connection between the strip-shaped element and the respective manipulating means, preferably an angle which ranges from 45 to 150 degrees, more preferably from 65 to 135 degrees and even more preferably from 90 to 120 degrees. When a user grabs the at least one manipulating means, and preferably the two manipulating means, the strip-shaped element can relatively easily be bent into a (more) open position by applying pressure to the manipulating means by means of the thumb and the finger.

The manipulating means may also be shaped differently, for example ring-shaped, in which case a user inserts a finger in the ring and can use it to pull the strip-shaped element into a (more) open position.

If the at least one manipulating means is adapted to be able to extend, at least in a rest position, at least substantially parallel to and adjoining the strip-shaped element, it is possible to prevent manipulating means from projecting inconveniently. Projecting manipulating means might injure users or might make it more difficult to insert the stems with the flower-binding device into the neck of a vase or make the latter even impossible in the case of a narrow vase.

It is preferred for the at least one manipulating means to be provided on the strip-shaped element so as to be pivotable, wherein the at least one manipulating means can pivot through an angle of 0 to 150 degrees, preferably to 135 degrees and more preferably to 120 degrees with respect to the strip-shaped element, in which case the angle encloses the short end and the respective manipulating means. At the zero-degree angle, the at least one manipulating means then adjoins the strip-shaped element, as a result of which it does not project in an inconvenient way in a rest position. At the maximum angle, the strip-shaped element bends open further when pressure is exerted on the at least one manipulating means in a direction in order to force the at least one manipulating means beyond this maximum angle.

If a free end piece of the at least one manipulating means is in this case click-fittable into the strip-shaped element, it is possible to prevent the at least one manipulating means from projecting in an undesirable or unintended way.

In a preferred embodiment according to the present inventive concept, the strip-shaped element, viewed in the longitudinal direction, that is to say with respect to the longitudinal direction, has at least one step. This may be an outwardly directed step, preferably an outwardly directed step next to the at least one manipulating means, on the side where the strip-shaped element is the longest. Thus, the step forms a stop for the at least one manipulating means, so that the at least one manipulating means cannot pivot beyond the maximum pivoting angle.

If the strip-shaped element, in a central portion, that is to say in a portion which is situated somewhere between two manipulating means, comprises a weakened section or thinned section or is made thinner than portions situated outside this portion of the strip-shaped element, bending of the strip-shaped element is facilitated.

According to the present inventive concept, a suitable load-free state of the strip-shaped element is achieved with a flower-binding device in which the strip-shaped element has a length L and, in the load-free state, ends of the first and the second end piece of the strip-shaped element extend a distance apart of between 0.0 and 0.2 times the length L of the strip-shaped element.

The locking means are preferably adapted to be able to lock the engagement means in various closed positions of the strip-shaped element. In this way, the flower-binding device can be locked around a bunch of flowers in various positions. This makes it possible to bind relatively large and relatively small bunches using the same (type/size of) flower-binding device, and/or to bind a bunch of flowers more tightly or more loosely.

If the engagement and locking means are detachable or releasable and preferably re-usable engagement and locking means, the flower-binding device can be reused, which is beneficial for the environment. In addition, it offers a person who has bought or been given a bunch of flowers the possibility to release the flower-binding device, to cut off ends of the stems of the flowers and to then re-use the flower-binding device to bind the bunch. Detachable engagement and locking means also offer the possibility to remove or replace unsightly flowers from the bunch by releasing the flower-binding device and locking it again after the unsightly flowers have been removed or replaced.

It is preferred if the strip-shaped element is made from a memory material. The strip-shaped element is pre-shaped in order to form a circular contour, and preferably in such a way that (the engagement means of) the first and the second end piece are aligned with respect to each other in such a way that the first and the second end piece automatically engage when the flower-binding device is squeezed and thus closed. If the flower-binding device is re-used, it is advantageous if the alignment is brought about again after use and if the original mutual distance between the first and the second end piece is replicated again.

If at least the strip-shaped element is made from at least substantially transparent material, the flower-binding device is not very conspicuous if a bound bunch of flowers is put in a glass vase. Alternatively, the flower-binding device may of course also be made more conspicuous and from a (semi-)opaque material, for example distinguishable in a color and/or with an imprint from a store (chain).

A thermoplastic, preferably polypropylene, is an excellent preferred material for the manufacture of the strip-shaped element. It is readily possible to achieve the above (preferred) properties using the former.

For environmental reasons, it is preferred if at least the strip-shaped element, and preferably the entire flower-binding device, is made from biodegradable material. When a bunch of flowers has reached the end of its life, it is usually disposed of with the green waste. Users do not always tend to remove accessories, such as a flower-binding device. A biodegradable flower-binding device does not result in contamination of the green waste stream, at least not in the long term.

It is practical if the strip-shaped element has a length in the range from 15 to 30 cm, preferably from 17 to 28 cm, more preferably from 20 to 26 cm. This length makes it possible to describe a contour which, on the one hand, is manipulatable with one hand and, on the other hand, can readily surround a bunch of flowers of common proportions without the end pieces overlapping to an inconveniently large degree.

If the strip-shaped element has a width in the range from 0.5 to 3 cm, preferably between 0.7 and 2.5 cm and more preferably between 1 and 2 cm, the strip-shaped element provides, on the one hand, sufficient support to a bunch of flowers of common proportions and is, on the other hand, relatively easily manipulable and is not too conspicuous around a bunch of flowers. In this case as well, it is possible to opt for a strip-shaped element that is wider than said range, or to provide the strip-shaped element with a widened section over a (limited) length, to distinguish the bunch of flowers or to allow for advertising.

The present inventive concept also relates to a method for binding a bunch of flowers. As described above, a bunch of flowers is bound according to a known method by means of an elastic band. The drawbacks of such a method have already been discussed above.

The present inventive concept also provides a method for binding a bunch of flowers which eliminates, or at least reduces, the drawbacks of the known method. To this end, the present inventive concept provides a method comprising the following steps:
providing a bunch of flowers with stems;
holding the stems of the bunch of flowers with one hand;
providing a flower-binding device according to the present inventive concept;
grasping the outer side of the flower-binding device using a thumb and a finger of the other hand;
manipulating the position of the strip-shaped element by means of the at least one manipulating means in such a way that an opening between the first and the second end piece of the strip-shaped element is sufficiently large to move the stems of the bunch of flowers sideways through the opening; and
squeezing the strip-shaped element in such a way that the engagement means of or on the strip-shaped element engage with each other.

The advantages of such a method correspond to the advantages of the flower-binding device according to the present inventive concept and are not discussed here in order to prevent unnecessary repetition.

If the method comprises the step of bringing the at least one manipulating means into a position adjoining the strip-shaped element, the risk of the flower-binding device, when used in connection with a bunch of flowers, causing damage or being difficult to manipulate due to projecting parts is greatly reduced, if not nullified.

### BRIEF DESCRIPTION OF THE DRAWINGS

The present inventive concept will be described in more detail below with reference to the attached drawings, in which:

FIG. 1 shows a perspective view of a flower-binding ring according to the present inventive concept, in the load-free state;

FIG. 2 shows a top view of the flower-binding ring from FIG. 1, in the load-free state;

FIG. 3 shows a perspective view of the flower-binding ring from FIGS. 1 and 2 in a bent-open position;

FIG. 4 shows a perspective view of the flower-binding ring from the previous figures in the closed position;

FIGS. 5a to 5c diagrammatically illustrate the operation of the flower-binding ring from the previous figures.

### DETAILED DESCRIPTION

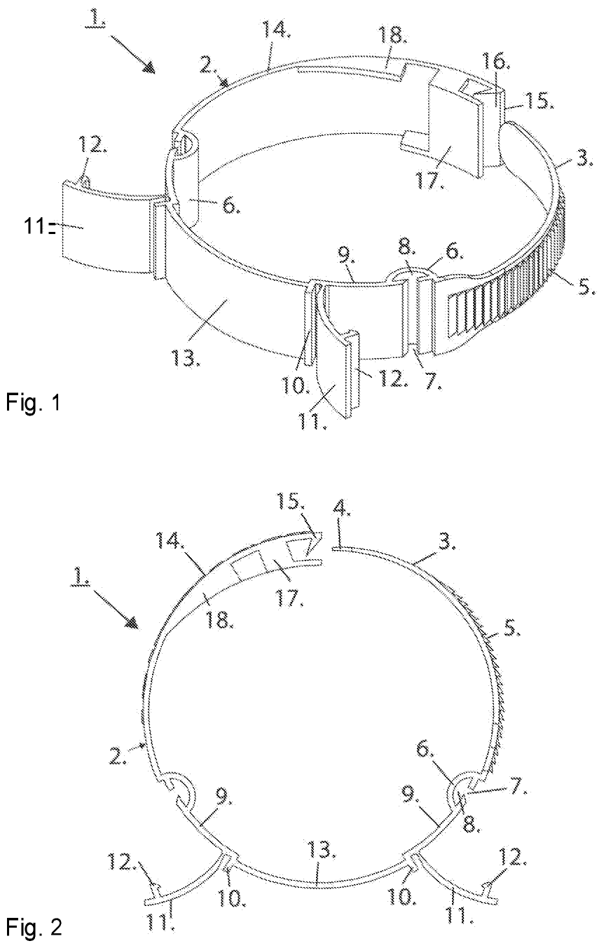

With regard to FIG. 1, a perspective top view of a flower-binding ring 1 is shown as an example of a flower-binding device according to the present inventive concept, in a load-free state. FIG. 2 shows a top view of the flower-binding ring 1. The flower-binding ring 1 has a plastic band 2 of, for example, transparent polypropylene (PP) as a strip-shaped or strip-like element. In the load-free state of the flower-binding ring 1, the band 2 is curved in the shape of a circle. The side facing the stems of a bunch of flowers during use is also referred to as the inner contour. The opposite side which faces away from the stems during use is referred to as the outer contour. After the flower-binding ring 1 is loaded and the load is removed in the non-engaging position, the band 2 substantially returns to the shape illustrated in FIGS. 1 and 2.

The band 2 has a few distinct segments. A first segment has a first end piece 3 which, in this exemplary embodiment, is narrower than the other segments. In addition, the first end piece 3 has a thinned section in the direction of a first end 4 of the band 2. At a distance from the first end 4, the first end piece 3 has a number of triangular teeth 5 which have a surface extending at, for example, right angles to the band 2 and an oblique surface extending in the direction of the first end.

The first end piece adjoins an incision 7 in the band 2 which is bridged by a diversion 6. Together with the diversion 6, the incision 7 forms a recess 8 in the band 2.

From the incision 7, the band extends away from the recess 8 via a first connecting part 9 with a length Lv up to a stop 10 which is at right angles, for example, to the first connecting part 9. A wing 11 is provided near the stop 10 as a manipulating means and is pivotable on the connecting part 9. Near the end of the wing 11 facing away from the band 2, there is a clamping hook 12 on the surface of the wing 11 facing the band 2. The distance between the clamping hook 12 and the pivot connection of the wing 11 and the band 2 corresponds to the length Lv of the connecting part 9. The wing 11 has a curvature which substantially corresponds to the curvature of the band 2 in the load-free state.

In a central portion, or a central part 13, the band 2 extends from the stop 10 to a second stop 10. In the present exemplary embodiment, the central part 13 is situated in the center of the band 2, but may equally be situated away from the center of the band 2 in other embodiments. In the exemplary embodiment, the central part 13 is as thick as the adjacent connecting parts 9. It may be advantageous to make the central part 13 thinner than the connecting parts, so that the central part 13 has less bending strength. The central part 13 is slightly outwardly offset with respect to the connecting parts 9.

Adjacent to the central part 13, there are provided the second stop 10 and a connecting part 9 on which a second wing 11 with a clamping hook 12 is arranged and which extends toward a second recess 8 which is formed by an incision 7 bridged by a diversion 6. For example, this is similar to the stop 10, the connecting part 9 and the recess 8 which are adjacent to the first end piece 3.

The band 2 subsequently runs up to the second end 15 of the band 2 as the second end piece 14. On the part situated close to the second end 15, in this exemplary embodiment on the second end 15, a barb 16 is provided on the second end piece 14. Near the second end 15, there is also provided a guide member 17 on the end piece 14 which is connected to the second end piece on mutually opposite side edges of the band 2 and as such forms a frame which is adapted for receiving the first end piece 3. On the inner side of the curve formed by the band 2, the second end piece 14 extends at an angle and subsequently substantially parallel to the second end piece 14 in the direction of the second end 15 of the band 2. In this exemplary embodiment, the guide member 17 forms the engagement means by cooperating with the band 2. In use, the teeth 5 and the barb 16 also engage with each other and form the locking means as the locking means. On a side of the second end piece 14 facing away from the second end 15, there is provided a guide element 18.

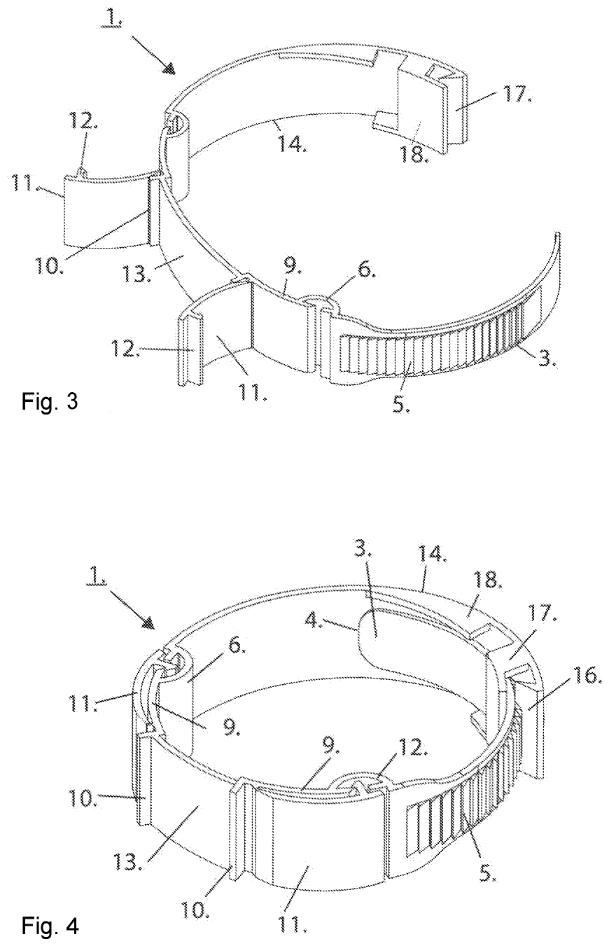

FIG. 3 shows the same flower-binding ring 1 in the bent-open position. That is to say in a position in which the two wings 11 of the flower-binding ring are/have been squeezed together, for example by means of fingers (not shown in FIG. 3). As a result, the shape of the central part 13 becomes straighter, leading to the first and the second end 4, 15 moving further apart.

FIG. 4 shows the flower-binding ring 1 in a closed position, that is to say, in a position in which the first and second end piece 3, 14 overlap each other and the first end piece 3 is accommodated in a frame which is formed by the barb 16 and the guide member 17. The wings 11 adjoin the outer contour of the band 2 and are securely click-fitted into the recesses 8 by means of the clamping hooks 12.

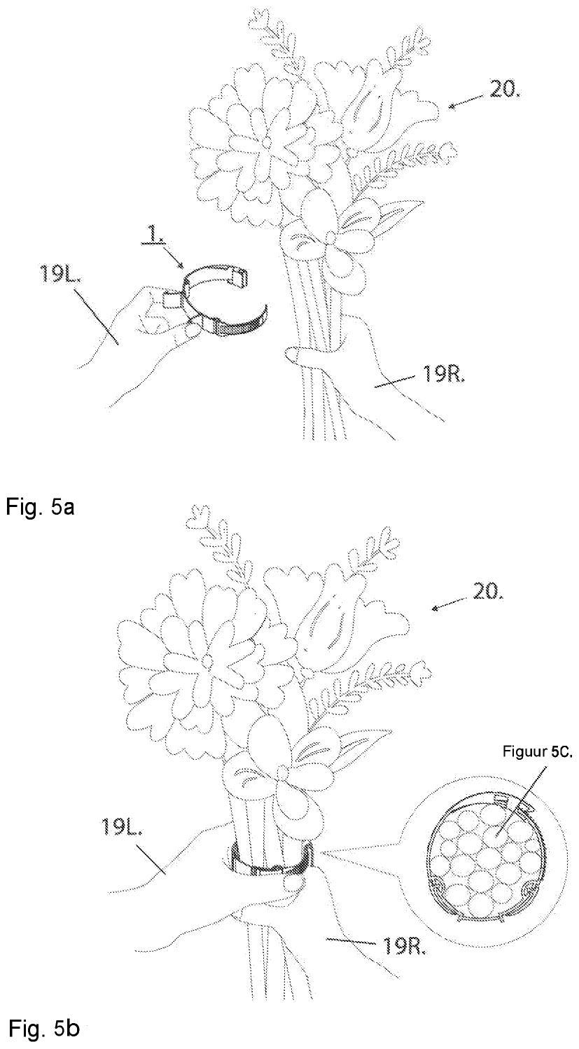

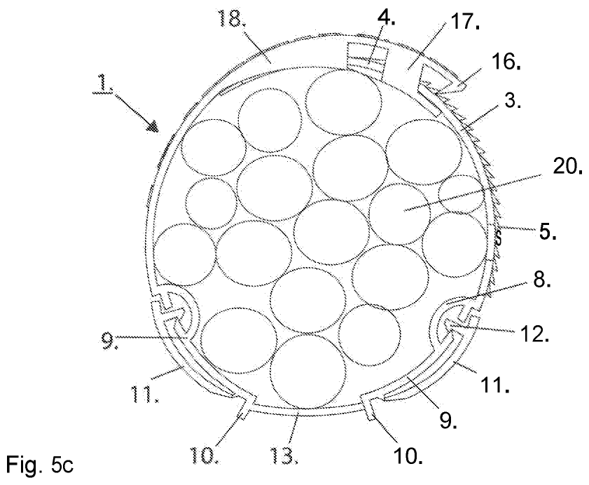

FIGS. 5a to 5c show the use of the flower-binding ring 1 when binding a bunch of flowers 20. In this example, a user is holding a bunch of flowers 20 at the stems of the flowers with his/her right hand 19r, for example just after the user has arranged the flowers. Subsequently, the user uses his/her left hand 191 to grasp the flower-binding ring 1 with his/her thumb and index finger at the wings 11 on the sides of the wings 11 which are turned away from one another. When the user grasps it, the flower-binding ring 1 is situated in the starting position illustrated in FIG. 1. The user squeezes the thumb and index finger slightly toward each other. This causes the wings 11 to be pushed against the respective stops 10 and in this case to act as levers. In this case, the stops 10 do not only act as a stop. Partly assisted by the fact that the central part 13 has an outwardly directed step with respect to the connecting parts 9, the stops 10 also function as hinges, making it possible to simplify the hinges due to the lever action of the wings. They pivot substantially about the connection between the central part 13 and themselves. The angle between the respective stop 10 and the adjoining connecting part 9 remains virtually constant, for example. The central part 13 is bent slightly inward. As a result thereof, the first and the second end 4, 15 of the band 2 move apart and a space is created between the ends 4, 15, as a result of which the flower-binding ring 1 can be moved around the stems of the bunch of flowers 20, preferably just above the right hand 19r. This situation is shown in FIG. 5a.

FIG. 5b shows the situation in which the stems of the bunch of flowers 20 have been introduced into the space between the two ends 4, 15 of the flower-binding ring 1 inside the contour of the flower-binding ring 1 and the flower-binding ring 1 has been closed. From the situation in FIG. 5a, the user moves the left and right hand 191, 19r toward each other and passes the stems of the bunch of flowers 20 between the two ends 4, 15 of the band 2. Once the stems are inside the contour of the flower-binding ring 1, the user reduces the pinching force on the wings 11 and finally withdraws this pinching force. The user now grasps the outer contour of the flower-binding ring 1, as a result of which the wings 11 of the respective stops 10 swivel out and subsequently extend substantially parallel, for example, to the outer contour of the band 2. If desired, the user may in this case temporarily remove his/her left hand 191 from the flower-binding ring 1 and allow it to rest on the right hand 19r. As the flower-binding ring 1 is nearly closed, it may not fall from the stems.

Subsequently, the user tightly squeezes his/her left hand 191 which holds the outer contour of the flower-binding ring 1. When the first end 4 of the band 2 approaches the second end piece 14, the first end 4 is caught in the space between the barb 16 and the guide member 17. The user squeezes his/her left hand 191 even tighter, as a result of which the first end piece 3 slides so far beyond the barb 16 that the barb 16 is able to engage with the teeth 5 on the first end piece 3. The outer contour of the first end piece 3 of the band 2 slides along the inner contour of the second end piece 14, the outer contour of the first end piece 3 being forced outward and against the inner contour of the second end piece 14 and against the barb 16 situated thereon by the guide member 17. Once the flower-binding ring 1 has been closed to a sufficient degree, with the user determining the degree of closure which is desired or sufficient, the user may release his/her left hand 191 from the flower-binding ring 1, as is illustrated in FIG. 5c. If the wings 11 were not click-fitted into the respective recesses 8 by means of the clamping hooks 12 when the flower-binding ring 1 was being fitted around the bunch of flowers 20, the user may do this subsequently. The end of a connecting part 9 facing away from the central part 13 is beveled, so that it forms a good guiding surface for the clamping hook 12.

FIG. 5c shows a cross-sectional view of the flower-binding ring 1 which surrounds the stems of the bunch of flowers 20 in the situation which is illustrated in FIG. 5b, which also corresponds to the situation in which the user has removed his/her left hand 191 from the flower-binding ring 1. As can be seen from FIG. 5c, the stems of the bunch of flowers 20 are securely held in the flower-binding ring 1. Although the outer contour of the flower-binding ring 1 is not entirely even, it does not have any inconvenient projections which could injure a user during “normal” use or which could make it more difficult to manipulate the bunch of flowers 20.

When a user wants to remove the flower-binding ring 1 from the bunch of flowers 20, he/she may do this by pressing the first end piece 3 of the band 2 slightly inward in the direction of the stems in order to stop the engagement of the barb 16 and the toothing 5 at the first end piece 3. The band 2 will tend to return to the initial shape shown in FIG. 1. In order to support this, the user may release the wings 11 from the respective recesses 8 and swing them outward beforehand, so that the wings 11 can be pushed toward each other using the thumb and the index finger in order to produce an opening between the first and second end 4, 15, so that the bunch of flowers 20 can be removed from the flower-binding ring 1 via this opening. A similar operation may be performed if a user wishes to remove a few flowers from the bunch. After he/she has released the flower-binding ring 1 and removed (or added) flowers, the flower-binding ring 1 may be closed again in the manner described above.

The flower-binding ring according to the present inventive concept and the use thereof have been described above by means of one exemplary embodiment shown in the figures. It will be clear that different modifications or alternatives, which may or may not be obvious to a person skilled in the art, are conceivable without departing from the scope of protection of the present inventive concept which is defined by the following claims.

The dimensions of parts of the flower-binding ring and the proportions between them may be varied, if desired or required. Here, the engagement means and the locking means are illustrated as being incorporated as teeth and a barb, but other kinds of engagement means and locking means which may optionally be incorporated therein are conceivable, such as for example a (slot-shaped) opening in the band itself through which an opposite end piece of the band or a cam which is provided thereon may be passed, or a hook and loop fastener. The manipulating means may be configured differently, for example may be designed as rings which are positioned closer to the ends and in which a user may insert a finger and a thumb in order to pull the flower-binding ring open. The band may have a pivot point, such as a ridge which extends over the width of the band.

### LIST OF REFERENCE NUMERALS

1 Flower-binding ring
2 Band
3 First end piece
4 First end
5 Teeth
6 Diversion
7 Incision
8 Recess
9 Connecting part
10 Stop
11 Wing
12 Clamping hook
13 Central part
14 Second end piece
15 Second end
16 Barb
17 Guide member
18 Guide element
19 Hand
20 Bunch of flowers

1. A flower-binding device for binding a bunch of flowers, the flower-binding device comprising:
a strip-shaped element with a first end piece and a second end piece, the strip-shaped element having a substantially circular shape in a load-free state;
engagement means for causing the first and the second end pieces to mutually engage with each other in an overlapping, closed position of the flower-binding device;
locking means for locking the engagement means in the closed position of the flower-binding device; and
at least one manipulating means on the strip-shaped element for manipulating the position of the strip-shaped element with one hand of a user, by adjusting a degree to which the first end piece and the second end piece of the strip-shaped element overlap each other or are spaced apart from one another, respectively.

2. The flower-binding device as claimed in claim 1, wherein the at least one manipulating means comprises two manipulating means.

3. The flower-binding device as claimed in claim 1, wherein the at least one manipulating means is provided on an outwardly facing side of the strip-shaped element and extends, at least in a manipulating position, at an angle with respect to the strip-shaped element.

4. The flower-binding device as claimed in claim 1, wherein the at least one manipulating means is adapted to be able to extend, at least in a rest position, at least substantially parallel to and adjoining the strip-shaped element.

5. The flower-binding device as claimed in claim 3, wherein the at least one manipulating means is provided on the strip-shaped element so as to be pivotable, wherein the at least one manipulating means can pivot through an angle of from 0 to 120 degrees with respect to the strip-shaped element.

6. The flower-binding device as claimed in claim 4, wherein a free end piece of the at least one manipulating means is click-fittable into the strip-shaped element.

7. The flower-binding device as claimed in claim 1, wherein the strip-shaped element, viewed in a longitudinal direction, has at least one step or wherein the strip-shaped element comprises a weakened section or thinned section in a central portion.

8. The flower-binding device as claimed in claim 1, wherein the strip-shaped element has a length and, in the load-free state, ends of the first and the second end pieces of the strip-shaped element extend a distance apart of between 0.0 and 0.2 times the length of the strip-shaped element.

9. The flower-binding device as claimed in claim 1, wherein the engagement and locking means are detachable or releasable engagement and locking means.

10. The flower-binding device as claimed in claim 1, wherein the strip-shaped element is made from a memory material.

11. The flower-binding device as claimed in claim 1, wherein at least the strip-shaped element is made from at least one of: substantially transparent material, polypropylene, a thermoplastic, or biodegradable material.

12. The flower-binding device as claimed in claim 1, wherein the strip-shaped element has a length in a range from 15 to 30 cm.

13. The flower-binding device as claimed in claim 1, wherein the strip-shaped element has a width in the range from 0.5 to 3 cm.

14. A method for binding a bunch of flowers, comprising the following steps:
providing a bunch of flowers with stems;
holding the stems of the bunch of flowers with one hand;
providing a flower-binding device as claimed in claim 1;
grasping an outer side of the flower-binding device using a thumb and a finger of the other hand;
manipulating the position of the strip-shaped element by means of the at least one manipulating means in such a way that an opening between the first and the second end pieces of the strip-shaped element is sufficiently large to move the stems of the bunch of flowers sideways through the opening; and
squeezing the strip-shaped element so the engagement means of or on the strip-shaped element engage with each other.

15. The method as claimed in claim 14, further comprising the step of bringing the at least one manipulating means into a position adjoining the strip-shaped element.

16. The flower-binding device as claimed in claim 1, wherein the strip-shaped element has a length in a range from 17 to 28 cm.

17. The flower-binding device as claimed in claim 1, wherein the strip-shaped element has a length in a range from 20 to 26 cm.

18. The flower-binding device as claimed in claim 1, wherein the strip-shaped element has a width in a range from 0.5 to 3 cm.

19. The flower-binding device as claimed in claim 1, wherein the strip-shaped element has a width in a range from 1 to 2 cm.

20. A flower-binding device for binding a bunch of flowers, the flower-binding device comprising:
a strip-shaped element with a first end piece and a second end piece, the strip-shaped element having a substantially circular shape in a load-free state;
a guide member for causing the first and the second end pieces to mutually engage with each other in an overlapping, closed position of the flower-binding device;
a fastener for locking the guide member in the closed position of the flower-binding device; and
at least one tab on the strip-shaped element for manipulating the position of the strip-shaped element with one hand of a user, by adjusting a degree to which the first end piece and the second end piece of the strip-shaped element overlap each other or are spaced apart from one another, respectively.

21. A method for binding a bunch of flowers, comprising the following steps:
providing a bunch of flowers with stems;
holding the stems of the bunch of flowers with one hand;
providing a flower-binding device as claimed in claim 20;
grasping an outer side of the flower-binding device using a thumb and a finger of the other hand;
manipulating the position of the strip-shaped element with the at least one tab so an opening between the first and the second end pieces of the strip-shaped element is sufficiently large to move the stems of the bunch of flowers through the opening; and
squeezing the strip-shaped element so the guide member of or on the strip-shaped element engages the first and second end pieces in an overlapping manner.
